(19) United States
(12) Patent Application Publication
(10) Pub. No.: US 2022/0080236 A1
(43) Pub. Date: Mar. 17, 2022

(54) FIRE SUPPRESSION SYSTEM

(71) Applicant: Woncheol Choi, San Jose, CA (US)

(72) Inventor: Woncheol Choi, San Jose, CA (US)

(21) Appl. No.: 17/020,597

(22) Filed: Sep. 14, 2020

(51) Int. Cl. A62C 3/02; B64F 1/36; B64F 1/18; B64F 1/22; B64C 39/02; B64D 41/00

(52) U.S. Cl. CPC A62C 3/0228; A62C 3/0271; B64F 1/362; B64F 1/18; B64C 2201/12; B64C 39/024; B64D 41/00; B64C 2201/027; B64F 1/22

(57) ABSTRACT

A drone-based fire suppression system is disclosed. According to one embodiment, the system includes: an unloader configured to detach a detachable part from a drone; a charging station configured to charge fire suppressant to the detachable part of the drone; and a loader configured to attach the detachable part that is charged by the charging station to the drone.

### FIELD

The field of the present disclosure relates generally to a fire suppression system, more particularly to a system and method for controlling and suppressing fires using one or more aerial vehicles such as drones.

### BACKGROUND

Wildfires are more prevalent and difficult to control, particularly during the hot and dry season. Uncontrolled wildfires result in devastating environmental, and financial losses, even loss of many lives. It is highly important to control and suppress wildfires effectively and promptly. in various terrains and environmental conditions.

Various types of aircrafts such as air tankers, water bomber planes, or helicopters with a bucket (e.g., Bambi Bucket®) are commonly used for aerial firefighting operations. Despite their common use for suppressing wildfires, such aircrafts have their limitations in aerial firefighting, for example, a longer response time, long reloading intervals, target accuracy and efficiency, accident risks, etc. A well-planned and accurate aerial firefighting operation is critical for battling wildfires in various terrains and environmental conditions.

In a conventional water spraying operation, for example, a garden water sprinkler system, most of the sprayed water misses a target area and is wasted, and only a small portion of the sprayed water reaches the target area. To overcome these limitations, a drip irrigation system delivers water to target areas more efficiently while saving water to achieve the same level of hydration. A similar approach may be taken in wildfires. Instead of conventional aerial firefighting operations using aircrafts dumping water that can miss a target wasting water, smaller flying vehicles such as drones can be more accurate and effective at controlling and suppressing wildfires.

### SUMMARY

A drone-based fire suppression is disclosed. According to one embodiment, a system includes: an unloader configured to detach a detachable part from a drone; a charging station configured to charge fire suppressant to the detachable part of the drone; and a loader configured to attach the detachable part that is charged by the charging station to the drone.

The system may further include a landing pad, wherein the landing pad may include an unloading zone and a loading zone, wherein the unloader may detach the detachable part from the drone in the unloading zone, and wherein the loader may attach the detachable part to the drone in the loading zone.

The landing pad may include one or more landing strips, and wherein a landing strip of the one or more landing strips may include a landing zone in which the drone lands, the unloading zone, the loading zone, and a take-off zone in which the drone takes off from the landing pad.

The system may further include a transport mechanism that may be configured to sequentially transport the drone in an order of the landing zone, through the unloading zone and the loading zone, and to the take-off zone.

The unloader may lower the detachable part after detaching the detachable part from the drone and may detach a battery pack from the detachable part.

The charging station may attach a charged battery pack to the detachable part.

The loader may raise the detachable part and attach the detachable part that is charged with the fire suppressant and the charged battery pack to the drone.

The system may further include a controller, wherein the controller is configured to: collect information about a fire; assess a condition of the fire based on the information; and determine a target location of the drone.

The information may include a current weather, a weather forecast, a direction and intensity of wind, humidity, visibility, air quality, an aerial image, a satellite image, an infrared image indicating hot spots, a terrain, and an environmental condition at or near the fire.

The system may further include a carrier configured to carry a plurality of drones and repeatedly load the detachable part of the drone.

According to one embodiment, a system includes: a plurality of drones, a drone of the plurality of drones having a detachable part; and a carrier an unloader configured to detach the detachable part from the drone, and a loader configured to attach the detachable part after the detachable part is charged.

The carrier may further include a landing pad and a charging station configured to charge fire suppressant to the detachable part of the drone.

The landing pad may include an unloading zone and a loading zone, wherein the unloader may detach the detachable part from the drone in the unloading zone, and wherein the loader may attach the detachable part to the drone in the loading zone.

The landing pad may include one or more landing strips, and wherein a landing strip of the one or more landing strips may include a landing zone in which the drone lands, the unloading zone, the loading zone, and a take-off zone in which the drone takes off from the landing pad.

The carrier may further include a transport mechanism that is configured to sequentially transport the drone in an order of the landing zone, through the unloading zone and the loading zone, and to the take-off zone.

The unloader may lower the detachable part after detaching the detachable part from the drone and may detach a battery pack from the detachable part.

The charging station may attach a charged battery pack to the detachable part.

The loader may raise the detachable part and attach the detachable part that is charged with the fire suppressant and the charged battery pack to the drone.

According to one embodiment, a method includes: providing a landing pad on a drone carrier, wherein the landing pad comprises an unloading zone and a loading zone; detaching a first detachable part from a drone that is landed on the landing pad, wherein the first detachable part comprises a first container and a first removable battery; providing a second container that is charged with fire suppressant; providing a second removable battery that is charged; attaching the second removable battery to the second container to form a second detachable part; and attaching the second detachable part to the drone.

The landing pad may include an unloading zone and a loading zone, and wherein the method may further include: detaching the first detachable part from the drone in the unloading zone; transporting the drone from the unloading zone to the loading zone; and attaching the second detachable part to the drone in the loading zone.

The above and other preferred features described herein, including various novel details of implementation and combination of elements, will now be more particularly described with reference to the accompanying drawings and pointed out in the claims. It will be understood that the particular methods and circuits are shown by way of illustration only and not as limitations of the claims. As will be understood by those skilled in the art, the principles and features of the teachings herein may be employed in various and numerous embodiments without departing from the scope of the claims.

### BRIEF DESCRIPTION OF THE DRAWINGS

The accompanying drawings, which are included as part of the present specification, illustrate presently preferred embodiment and together with the general description given above and the detailed description of the preferred embodiment given below serve to explain and teach the principles described herein.

FIG. 1 illustrates a fire suppression system, according to one embodiment;

FIG. 2 illustrates a loading/unloading system, according to one embodiment;

FIG. 3 shows a block diagram of a fire suppression system, according to one embodiment; and

FIG. 4 illustrates a control map of a fire site according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the present disclosure including the claims.

### DETAILED DESCRIPTION

In the following description, for purposes of explanation only, specific nomenclature is set forth to provide a thorough understanding of the present disclosure. However, it will be apparent to one skilled in the art that these specific details are not required to practice the inventive concepts described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings as described herein.

Moreover, various features of the representative examples disclosed herein may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The above and other preferred features described herein, including various novel details of implementation and combination of elements, will now be more particularly described with reference to the accompanying drawings and pointed out in the claims. It will be understood that the particular methods and circuits are shown by way of illustration only and not as limitations of the claims. As will be understood by those skilled in the art, the principles and features of the teachings herein may be employed in various and numerous embodiments without departing from the scope of the claims.

The present disclosure provides a new paradigm for controlling and suppressing fires such as wildfires and bush fires. The present system and method utilizes a fleet of drones for conducting an orchestrated and efficient aerial firefighting operation.

The fleet of drones may be carried by a drone carrier and deployed near a target site. Examples of the drone carrier include a fire engine, a truck, etc., but the present disclosure is not limited to these examples. In another example, the drone carrier may be an aircraft, a large drone, or a boat that can carry a plurality of firefighting drones.

Each drone may carry a fire suppressant such as water, fire retardant, and firefighting foam to extinguish the flaming and glowing phases of combustion by applying the fire suppressant to burning fuels. Fire retardant may be a mixture of water and a chemical used to slow down or stop the spread of fire or reduce its intensity. Firefighting foam is an aerated solution created by forcing air or gas into, or entraining air within, water containing a foam concentrate. Foam reduces combustion by cooling, moistening, and excluding oxygen. Each drone may have a limited fire suppressant carrying capacity, but the entire fleet of the drones can continuously apply and drop the fire suppressant at or near the target site with shorter intervals to control and suppress the fire highly effectively.

The present system and method utilizing a fleet of drones provides various advantages for aerial firefighting operations. The drones could fly autonomously in a group or a subgroup to battle a fire more efficiently. The drones (e.g., firefighting drones) can fly lower and closer to a flame area compared to a conventional aerial firefighting aircrafts and accurately drop fire suppressant on a target area. Each drone may have a different target area to more efficiently battle the fire. The target area for each of the drones may be accurately determined based on the continuous monitoring the current condition of the fire. The target area of the drones may be determined based on not only the current condition but also prediction of the progress of the fire.

Each of the drones may fly to a designated target area that may follow a fire line or a control line of the fire, hot spots, etc. The fire line and the control line of the fire may constantly change depending on the progression of the fire; therefore the designated target area of the drones may vary by assessing the current condition and predicting the progression of the fire line. A group of drones can target a specific hot spot or along a fire/control line and drop fire suppressant accurately. The overall the aerial firefighting operation using the drones includes the assessment, prediction, planning target areas, loading and reloading a fire suppressant may be orchestrated based on a battle plan. The operation of the drones can be cost effective, and it can be further scaled up or down based on the condition of the fire. The drones may have less limitation of the resource of the fire suppressant. Furthermore, the aerial firefighting operation using autonomous drones is much safer compared to pilot-operated airplanes or helicopters.

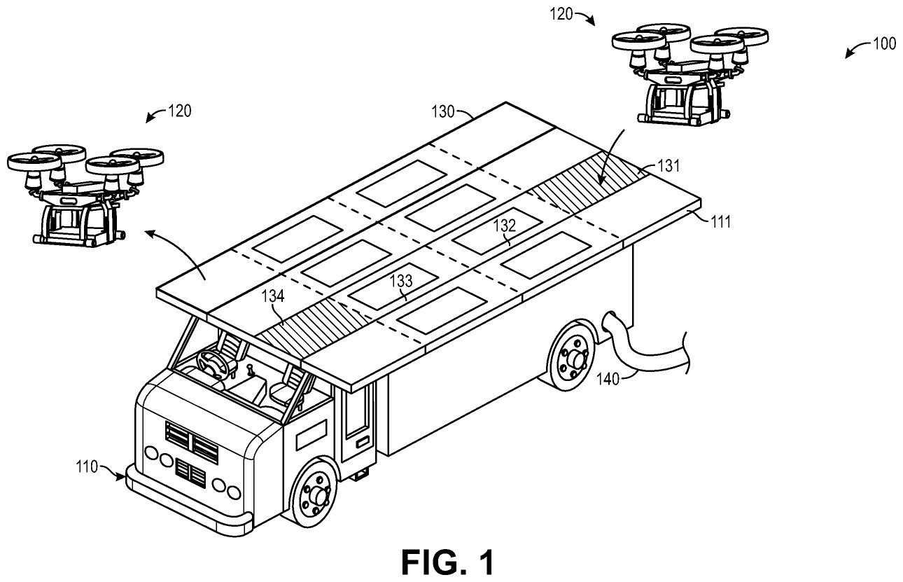

FIG. 1 illustrates a fire suppression system, according to one embodiment. A system 100 includes a drone carrier 110 and a plurality of drones 120. The drone carrier 110 can carry the plurality of drones 230 on a landing pad 111. The drones 120 may be coupled and secured to the landing pad 111 via a secure coupling mechanism (not shown).

The drone carrier 110 can dispatch the drones 120 to a location close to a fire site. The drone carrier 110 may be a truck or a fire engine equipped to have the landing pad 111 and carry the drones 120. In some embodiment, the drone carrier 110 may be an aircraft, another drone, a boat, of the like. The drone carrier 110 may take the drones 120 to a close location that is accessible, but it would be parked at a sufficient distance away from the fire location for safety and/or logistics issues. The drone carrier 110 has a supply line 140 for supplying fire suppressant such as water and fire retardant. In one embodiment, the fire suppressant may be carried by the drone carrier 110 or another vehicle or supplied from an external source.

Although the drone 120 may have a limited fire suppressant carrying capacity, it can fly closer to a target location at the fire site compared to a conventional aerial firefighting aircraft. Therefore, the drone 120 can spray fire suppressant more accurately on the target location. After completing the mission of spraying, the drone 120 returns to the drone carrier 110 and lands on the landing pad 111 to reload the fire suppressant. If necessary, the drone 120 may be reloaded with a charged battery as well. After reloading the fire suppressant and/or the battery, the drone 120 takes off from the landing pad 111 and flies back to the fire site. The target location assigned to the drone 120 may change at each mission depending on the progression and containment of the fire.

According to one embodiment, the landing pad 111 includes a plurality of landing strips 130. FIG. 1 illustrates four landing strips 130 merely as an example; however, it is understood that the carrier 110 may have any number of landing strips of landing strips 130 without deviating from the scope of the present disclosure.

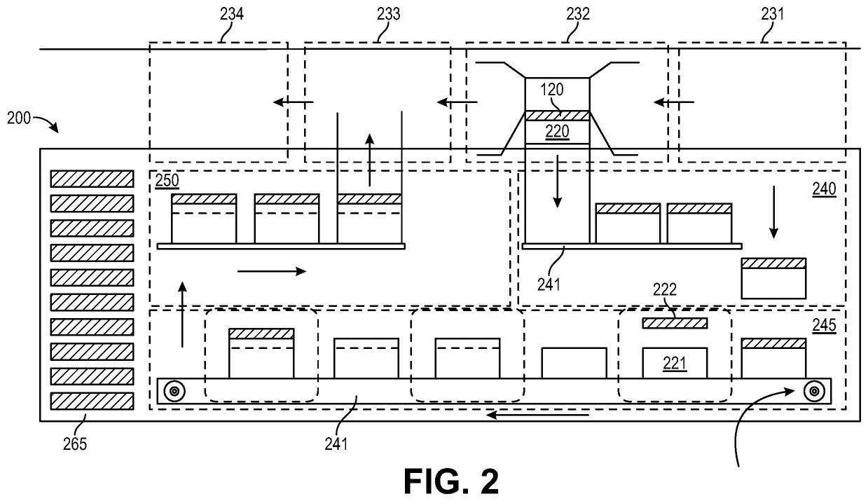

Each landing strip 130 has a landing zone 131, an unloading zone 132, a loading zone 133, and a take-off zone 134. After dumping the loaded fire suppressant at the fire site, the drone 120 lands at the landing zone 131 of the landing strip 130. In the present example of having four landing strips 130, four drones 120 may land simultaneously. The drone 120 then moves to the unloading zone 132. In the unloading zone 132, the empty fire suppressant tank and/or the drained battery pack of the drone 120 are unloaded by an unloading mechanism (see FIG. 2). After unloading the fire suppressant tank and/or the drained battery pack, the drone 120 moves to the loading zone 133. In the loading zone 133, the drone 120 is loaded with a full tank of fire suppressant and/or the fully charged battery pack. After loading, the drone 120 is moved to the take-off zone 134 and is ready to take off for the next mission.

FIG. 2 illustrates a loading/unloading system, according to one embodiment. A loading/unloading system 200 includes a landing zone 231, an unloading zone 232, a loading zone 233, a take-off zone 234. The loading/unloading system 200 further includes an unloader 240, a charging station 245, and a loader 250. The landing zone 231, the unloading zone 232, the loading zone 233, and the take-off zone 234 may respectively correspond to various parts of a landing strip (e.g., the landing strip 130 shown in FIG. 1). According to one embodiment, the landing zone 231, the unloading zone 232, the loading zone 233, and the take-off zone 234 may respectively correspond to the landing zone 131, the unloading zone 132, the loading zone 133, and the take-off zone 134 of FIG. 1. The drone carrier 110 of FIG. 1 may implement the loading/unloading system 200 under the landing pad 111.

First, the drone 120 that has an empty tank or completed a mission is placed or lands in the landing zone 231 of the loading/unloading system 200. The drone 120 may be made to be modular to have a detachable part 220. The detachable part 220 of the drone 120 may include a tank 221 that can contain fire suppressant. The drone 120 is sequentially moved in the order of the landing zone 231, the unloading zone 232, the loading zone 233, and the take-off zone 234. In one embodiment, the loading/unloading system 200 may include a first transport mechanism (not shown) to transport mechanisms (e.g., a conveyer belt) to sequentially transport the drone 120 in the order of the landing zone 231, the unloading zone 232, the loading zone 233, and the take-off zone 234 and a second transport mechanism (e.g., a transporter 241) to transport the detachable part 220 that is detached from the drone 120 from the unloader 240 to the loader 250.

After the drone 120 is transported from the landing zone 231 to the unloading zone 232, the unloader 240 detaches the detachable part 220 of the drone 120 from the drone 120 and lowers the detachable part 220 onto a transporter 241. In one embodiment, the unloader 240 detects the drone 120 that has arrived in the unloading zone 232 and detaches the detachable part 220 from the drone 120. The transporter 241 may be a conveyor belt. Using the transporter 241, the unloader 240 may transport the detachable part 220 to the charging station 245.

Referring to FIGS. 1 and 2, the drone 120 may be transported in an upper tier, for example, on the landing pad 111 of the drone carrier 110, and the detachable part 220 may be transported in a lower upper tier, for example, below the landing pad 111 of the drone carrier 110. In this configuration, the space on the landing pad 111 is maximized to have multiple drones 120 landed at the same time, while their detachable parts are charged and reloaded by the loading/unloading system 200 that is placed under the landing pad 111.

According to one embodiment, the detachable part 220 of the drone 120 may integrate a battery pack 222. When the detachable part 220 is detached from the drone 120 by the unloader 240, the tank 221 and the battery pack 222 may be removed together, and the unloader 240 may separate the tank 221 and the battery pack 222 thereafter.

The empty tank 221 is transported from the unloader 240 to the charging station 245 via the transporter 241. Although FIG. 2 illustrates that the unloader 240, the loader 250, and the charging station 245 are arranged in a vertical arrangement, the present disclosure is not limited thereto. In one embodiment, the unloader 240, the loader 250, and the charging station 245 are arranged may be arranged in a horizontal arrangement. In this case, the detachable part 220 may be transported primarily in a single plane without any vertical transportation. On another embodiment, the charging station 245 may be placed under the unloader 240 and/or the loader 250.

The charging station 245 may fill the empty tank 221 with fire suppressant. In one embodiment, the charging station 245 may transport the empty tank 221 to a separate refill station (not shown), and a full tank 221 may be placed on the transporter 241 to save the charging time.

The full tank 221 is moved to the next stage in the charging station 245. For example, a fully charged battery pack 222 is attached to the full tank 221 to prepare a freshly loaded and fully charged detachable part 220 ready to be attached to the drone 120. The loaded detachable part 220 is transported to the loader 250, where the detachable part 220 is raised to the loading zone 233 and attached to the drone 120. The drone 120 is then loaded with the full tank 221 of fire suppressant and a fully charged battery pack 222. The loaded drone 120 may be transported to the take-off zone 234 ready for the next mission.

According to one embodiment, the discharged battery pack 222 that is detached from the drone 120 in the unloader 240 is transported to a battery charging station 265, where the discharged battery pack 222 is charged. A fully charged battery pack 222 in the battery charging station 265 may be transported to the charging station 245 and attached to the fully charged tank 221 to prepare a freshly loaded detachable part 220 for the drone 120.

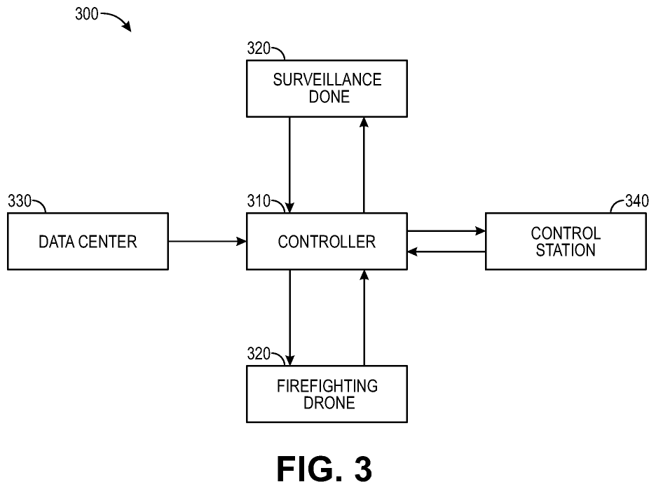

FIG. 3 shows a block diagram of a fire suppression system, according to one embodiment. A system 300 may include a controller 310 and a plurality of drones 320. The plurality of drones 320 may include one or more surveillance drones 321 and one or more firefighting drones 322. The drones 320 may be one of the drones 120 described above with reference to FIG. 1. The system 300 may further include a data center 330 and a control station 340.

The controller 310 may receive information pertaining to a fire of interest from various information sources, and assess conditions and complexity of the fire. Based on the assessment of the conditions and complexity of the fire, the controller 310 generate a battle plan to suppress the fire and provide controls of the drones 320. Since the conditions and complexity of the fire continuously changes, the controller 310 may keep receiving updated information about the fire, reassess the conditions and complexity, and adjust the plan, as necessary.

The data center 330 may provide information about the fire to the controller 310. The data center 330 may refer to a single entity that aggregates the information and provides the aggregated information to the controller 310, or it may refer to multiple entities, each of which provides its own information to the controller 310. Examples of such information provided to the controller 310 include, but are not limited to, a current weather, a weather forecast, a direction and intensity of wind, humidity, visibility, air quality, an aerial image, a satellite image, an infrared image indicating hot spots, a terrain, and various environmental conditions at or near the fire site. The data center 330 may provide the information to the controller 310 real-time.

These information provided by the data center 330 may be useful for the controller 310 to more accurately assess the conditions and complexity of the fire and generate and/or adjust a plan to battle the fire at interest more efficiently. The controller 310 processes these information and may generate a fleet-level mission as well as an individualized mission for each of the drones 320. The controller 310 may control, manage, and deploy the drones 320 based on the battle plan.

In one embodiment, the controller 310 provides a flying path, a target location of each of the drones 320. The target location may include a fire suppressant release location and the altitude (e.g., a height or a range of height from a hot spot). The target location of the drones 320 may be different from each other, and the controller 310 may orchestrate the control of the drones 320 by providing their flying paths and target locations. In one embodiment, each of the drones 320 may have an autonomous flying capability and avoid collision with other drones using various sensors. In this case, the controller 310 may only provide a target location to each of the drones 320.

In one embodiment, the controller 310 may determine the target location based on a battery capacity and an estimated flying time of a drone 320. The initial flying time of the drone may be updated even while conducting a mission due to the change of a flying path and time of the drone because the estimated flying time may be shortened by the gust and heavy smoke. Based on the current assessment of the flying time and the current target location, the drone 320 may not be able to complete the current mission. In this case, the controller 310 may change the current mission by providing a new target location that can be completed so that the drone 320 can safely return, for example, to the drone carrier 110 of FIG. 1.

Some of the drones 320, for example, the surveillance drones 321, that are conducting a fire suppressant dropping mission at or near the target site may provide information of the fire to the controller 310. The controller 310 aggregates the information collected by the drones 320 and assess the current conditions and complexity of the fire in conjunction with the information provided by the data center 330. Based on the aggregated information, the controller 310 may predict how the fire would progress and spread. Assessing the current conditions and the predicted progression, the controller 310 may provide updated target locations for the drones 320. This allows the drones 320 to attack more accurately planned target locations to efficiently battle the fire.

According to one embodiment, a group of the drones 320, herein also referred to as surveillance drones 321, may be dedicated for flying around the target site while other drones, herein also referred to as firefighting drones 322, may carry out the fire suppressant dropping missions. This may be useful when the firefighting drones 322 that are commanded to fly close to the target site for optical fire suppressant dropping may have impaired visibility by the fire and/or the smoke. The surveillance drones 321 may capture the progression and more up-close conditions of the fire and send the captured information to the controller 310 by flying near the target site but not too close so that they can monitor the conditions of the fire by keeping a safe distance to the intense flames, hot spots, and heavy smokes (e.g., a fire whirl, a fire tornado). The surveillance drones 321 continuously monitor the condition and keep an appropriate distance from the flames and smokes because the current condition of the fire may rapidly change, and that the present system and method adaptively respond to the rapid changes by continuously monitoring the conditions and changing the battle plan, as necessary. Since the surveillance drones 321 may not carry a load of fire suppressant, they may have a longer flying time than the firefighting drones 322 and acquire views covering a larger area around the target site to help the controller 310 to better assess the conditions of the fire. Depending on the need for surveillance and firefighting, the controller 310 may change the number of the surveillance drones 321 and the number of the firefighting drones 321. A surveillance drone 321 may be converted to a firefighting drone 322 by attaching a container of fire suppressant, and similarly a firefighting drone 322 may be converted to a surveillance drone 321 by detaching a container of fire suppressant. Attaching/detaching a container or a tank to a drone 320 is described in detail with reference to FIG. 2 above.

According to one embodiment, the controller 310 may create and continuously update a battle plan of the fleet of drones 320. For example, the controller 310 may determine target locations of the firefighting drones 322 based on the current and predicted conditions of the fire. The firefighting drones 322 may be grouped together to complete a group mission. For example, a subgroup of the firefighting drones 322 may drop fire suppressant along a control line (or a fire line, or a wet line) while another subgroup of the firefighting drones 322 may drop fire suppressant along a different control line. A control line refers to constructed or natural barriers and retardant-treated fire edges used to control a fire. A fire line refers to a part of a control line that may be scraped or dug to mineral soil. A wet line serves as a temporary control line from which to ignite or stop a low-intensity fire.

According to one embodiment, the firefighting drones 322 may be categorized into different groups depending on a fire suppressant that they carry, for example, water, fire retardant, firefighting foam, etc. For example, a first group of firefighting drones 322 may carry and drop fire retardant at a designated site, and a subsequent group of firefighting drones 322 that may carry and drop water or firefighting foam at the same designated site according to a battle plan. Even during a flight to a designated target location, the controller 310 may provide a firefighting drone 322 with an updated target location that may be different from the originally designated target location as the circumstances can quickly change at or near the target site.

According to one embodiment, the controller 310 communicates with the control station 340. The control station 340 may communicate with more than one controllers 310 to orchestrate battle plans of a complex fire. Each fleet of drones corresponding to one controller 310 may cover a smaller area at the fire site, but a plurality of fleets of drones may be deployed at the same fire site, and the control station 340 provides a fleet-level control of the drones by communicating with each of the controllers 310. In some cases, more than one fires merge and grow to a complex fire. In this case, the control station 340 may establish communication with controllers 310 that are under control of a different control station 340.

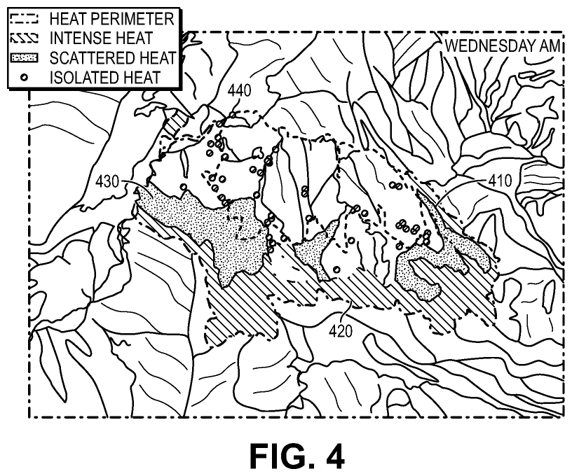

FIG. 4 illustrates a control map of a fire site according to one embodiment. A control map 400 identifies areas and spots of interest to determine target locations of drones. The image 400 identifies a heat perimeter 410, an area of intense heat 420, an area of scattered heat 430, and hot spots 440. In one embodiment, the controller 310 of FIG. 3 may generate the control map 400.

Referring to FIG. 3, the controller 300 may determine target locations for each of the drones 320 based on the control map 400. The areas and spots in the control map 400 may be identified based on information provided by the data center 330 and the drones 320 (e.g., the surveillance drones 321) of FIG. 3. The drones 320 may be grouped together to attack each of the target area or spot based on the assessment of the current conditions and complexity of the fire by the controller 310 and/or the control station 340. The target locations of the drones 320 may be different from each other and continuously updated based on the current conditions and predicted progression of the fire. For example, for each hot spot 440, the controller 310 may set a control line and deploy drones 320 to battle the identified hot spot 440. Each of the drones 320 may have an individualized target location along the control line or a perimeter of the control line. Depending on the intensity of the heat, for example, the area of intense heat 420 and the area of scattered heat 430, the density of the target locations designated to the drones may vary. For example, in the area of intense heat 420, more drones are deployed, and in the area of scattered heat 430, a relatively smaller number of drones may be deployed. For the hot spots that are closer to a residential area, more drones are deployed to divert the progression of the fire away from the residential area.

A drone-based fire suppression system has been disclosed. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

We claim:

1. A system comprising:
an unloader configured to detach a detachable part from a drone;
a charging station configured to charge fire suppressant to the detachable part of the drone; and
a loader configured to attach the detachable part that is charged by the charging station to the drone.

2. The system of claim 1 further comprises a landing pad,
wherein the landing pad comprises an unloading zone and a loading zone,
wherein the unloader detaches the detachable part from the drone in the unloading zone, and
wherein the loader attaches the detachable part to the drone in the loading zone.

3. The system of claim 2, wherein the landing pad includes one or more landing strips, and wherein a landing strip of the one or more landing strips includes a landing zone in which the drone lands, the unloading zone, the loading zone, and a take-off zone in which the drone takes off from the landing pad.

4. The system of claim 3 further comprises a transport mechanism that is configured to sequentially transport the drone in an order of the landing zone, through the unloading zone and the loading zone, and to the take-off zone.

5. The system of claim 1, wherein the unloader lowers the detachable part after detaching the detachable part from the drone and detaches a battery pack from the detachable part.

6. The system of claim 5, wherein the charging station attaches a charged battery pack to the detachable part.

7. The system of claim 6, wherein the loader raises the detachable part and attaches the detachable part that is charged with the fire suppressant and the charged battery pack to the drone.

8. The system of claim 1 further comprises a controller, wherein the controller is configured to:
collect information about a fire;
assess a condition of the fire based on the information; and
determine a target location of the drone.

9. The system of claim 1, wherein the information includes a current weather, a weather forecast, a direction and intensity of wind, humidity, visibility, air quality, an aerial image, a satellite image, an infrared image indicating hot spots, a terrain, and an environmental condition at or near the fire.

10. The system of claim 1 further comprises a carrier configured to carry a plurality of drones and repeatedly load the detachable part of the drone.

11. A system comprising:
a plurality of drones, a drone of the plurality of drones having a detachable part; and
a carrier an unloader configured to detach the detachable part from the drone, and a loader configured to attach the detachable part after the detachable part is charged.

12. The system of claim 11, wherein the carrier further comprises a landing pad and a charging station configured to charge fire suppressant to the detachable part of the drone.

13. The system of claim 12, wherein the landing pad includes an unloading zone and a loading zone,
wherein the unloader detaches the detachable part from the drone in the unloading zone, and
wherein the loader attaches the detachable part to the drone in the loading zone.

14. The system of claim 13, wherein the landing pad includes one or more landing strips, and wherein a landing strip of the one or more landing strips includes a landing zone in which the drone lands, the unloading zone, the loading zone, and a take-off zone in which the drone takes off from the landing pad.

15. The system of claim 14, wherein the carrier further comprises a transport mechanism that is configured to sequentially transport the drone in an order of the landing zone, through the unloading zone and the loading zone, and to the take-off zone.

16. The system of claim 12, wherein the unloader lowers the detachable part after detaching the detachable part from the drone and detaches a battery pack from the detachable part.

17. The system of claim 16, wherein the charging station attaches a charged battery pack to the detachable part.

18. The system of claim 17, wherein the loader raises the detachable part and attaches the detachable part that is charged with the fire suppressant and the charged battery pack to the drone.

19. A method comprising:
providing a landing pad on a drone carrier, wherein the landing pad comprises an unloading zone and a loading zone;
detaching a first detachable part from a drone that is landed on the landing pad, wherein the first detachable part comprises a first container and a first removable battery;
providing a second container that is charged with fire suppressant;
providing a second removable battery that is charged;
attaching the second removable battery to the second container to form a second detachable part; and
attaching the second detachable part to the drone.

20. The method of claim 19, wherein the landing pad comprises an unloading zone and a loading zone, and wherein the method further comprising:
detaching the first detachable part from the drone in the unloading zone;
transporting the drone from the unloading zone to the loading zone; and
attaching the second detachable part to the drone in the loading zone.
